(19) United States
(12) Patent Application Publication
(10) Pub. No.: US 2023/0334458 A1
(43) Pub. Date: Oct. 19, 2023

(54) SNAPit-UP - AUTOMATED ASSISTANCE PROGRAM BASKET PRODUCT GENERATOR AND ASSOCIATED POINT OF SALE SYSTEM

(71) Applicant: Kimberly D. Carter, Lakeland, FL (US)

(72) Inventor: Kimberly D. Carter, Lakeland, FL (US)

(21) Appl. No.: 18/094,341

(22) Filed: Jan. 6, 2023

Related U.S. Application Data
(60) Provisional application No. 63/296,854, filed on Jan. 6, 2022.

(51) Int. Cl. G06Q 20/20; G06Q 20/24; G06Q 20/40

(52) U.S. Cl. CPC G06Q 20/24; G06Q 20/208; G06Q 20/405

(57) ABSTRACT

Methods, systems and computer readable media to provide automated assistance program basket (e.g., SNAP basket) product generator and associated point of sale system and services, are described.

### RELATED APPLICATIONS

This application claims the benefit of U.S. Application No. 63/296,854, entitled “SNAPit-UP - Automated Assistance Program Basket Product Generator And Associated Point Of Sale System,” and filed on Jan. 6, 2022, which is incorporated herein by reference in its entirety.

### TECHNICAL FIELD

Embodiments relate generally to point of sale systems, and more particularly, to methods, systems and computer readable media for automated assistance program (such as SNAP) basket product generator and point of sale systems to electronically verify compliance and conduct electronic basket transactions.

### BACKGROUND

Some food assistance programs provided by governments (e.g., the Supplemental Nutrition Assistance Program or SNAP administered by the U.S. Department of Agriculture) may have restrictions on those products or items that can be purchased with assistance funds (“approved items”) and those which cannot (“non-approved items”). Often, beneficiaries of the assistance programs and retailers that accept payments form such programs are unaware that options exist to include non-approved items within a special type of purchase that includes approved items if the purchase meets specific criteria. Because of the specific nature of the rules and the general lack of information about such rules, consumers and retailer may not exercise their options and thus such options are not programmed into conventional point of sale systems.

Some implementations were conceived in light of the above-mentioned needs, problems and/or limitations, among other things.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a diagram showing an example environment including an example automated assistance program basket (e.g., SNAP basket) product generator and associated point of sale system in accordance with some implementations.

FIG. 2 is a flowchart showing an example method for automated assistance program basket (e.g., SNAP basket) product generation and user checkout via a point-of-sale system in accordance with some implementations.

FIG. 3 is a diagram showing an example environment including an example handheld electronic automated assistance program basket (e.g., SNAP basket) product generator and associated point of sale system in accordance with some implementations.

FIG. 4 is a flowchart showing an example method for automated assistance program basket (e.g., SNAP basket) product generation and user checkout via a combination of a handheld scanner and an associated point-of-sale system in accordance with some implementations.

FIG. 5 is a diagram of an example computing device configured for electronic employment document control in accordance with at least one implementation.

### DETAILED DESCRIPTION

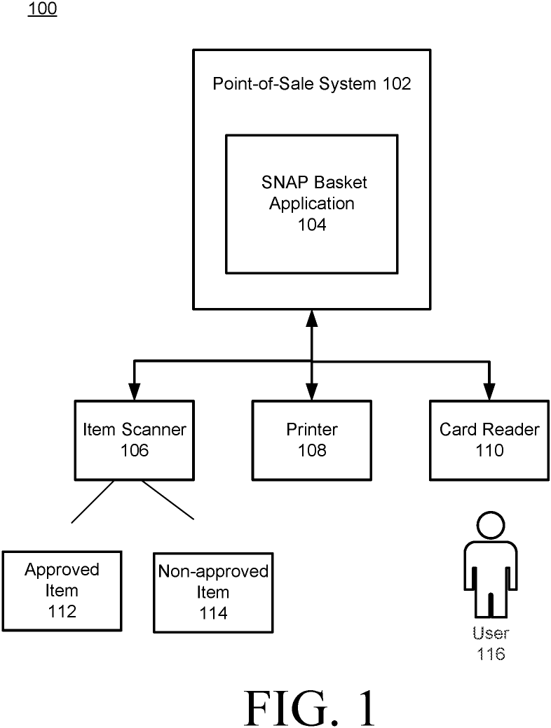

FIG. 1 is a diagram showing an example environment 100 including an example automated assistance program basket (e.g., SNAP basket) product generator and associated point of sale system in accordance with some implementations. In particular, FIG. 1 shows a point-of-sale system 102 that includes an assistance program basket application 104 (e.g., SNAP basket). Coupled to the point-of-sale system 102 are an item scanner 106, a printer 108, and a card reader 110.

In operation, a user 116 provides one or more items to be scanned. The items can include one or more approved items 112 and one or more non-approved items 114. The point-of-sale system 102 scans the items 112/114 using the scanner 106 (e.g., a barcode scanner or the like) and builds an assistance program basket as described herein. The assistance program basket may have a unique SKU and/or bar code. The bar code can be printed from the printer 108 and scanned as its own item in place of the individual items 112/114 scanned as part of the basket building process. Also, the barcode for the basket can be provided to the user 116 (or customer) so that the user can use that bar code for similar basket purchases in the future.

Once the basket has been created and added to the customer’s order (and the individual items removed or deleted), the customer 116 can pay via assistance program card via the card reader 110 and pay any additional funds using traditional payment methods (e.g., cash, check, credit card, debit card, or the like).

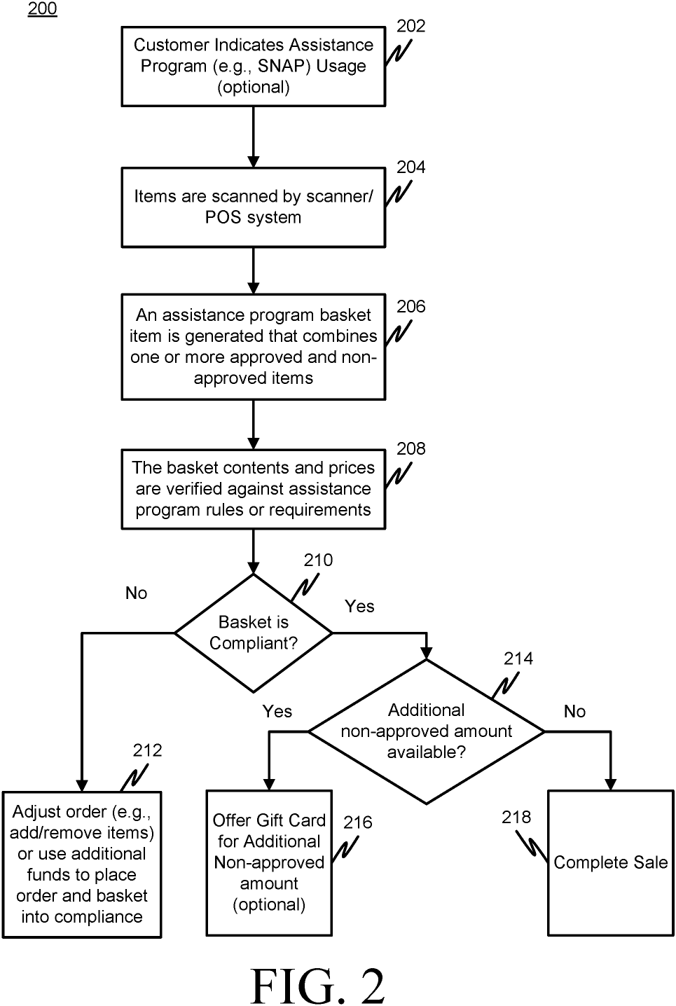

FIG. 2 is a flowchart showing an example method 200 for automated assistance program basket (e.g., SNAP basket) product generation and user checkout via a point-of-sale system in accordance with some implementations. Processing beings at 202, where a user or customer indicates a desire to use an assistance program form of payment (e.g., SNAP funds, EBT card, or the like). For example, in some implementations, a user or customer can scan a computer readable indicium (e.g., a QR code) to learn more about the assistance program baskets and/or to start the process of creating a basket for checkout. Processing continues to 204.

At 204, items are scanned by the POS/scanner, The items can include one or more approved items and, optionally, one or more non-approved items. Processing continues to 206.

At 206, an assistance program basket item (e.g., a SNAP basket) is generated by a basket application that is part of or coupled to the POS, where the basket combines one or more approved items and, optionally, one or more non-approved items. Processing continues to 208.

At 208, the basket contents and prices are used to verify compliance with assistance program rules, requirements or guidelines. For example, in some assistance programs such as SNAP, the non-approved item total must be less (even if by only $0.01) than the approved item total. Processing continues to 210.

At 210, the system determines if the basket is compliant. If so, processing continues to 214. If not, processing continues to 212.

At 212, the customer’s order can be adjusted (e.g., one or more approved or non-approved items removed or added) or the customer can provide additional non-assistance program funds to place the basket order into compliance (e.g., by moving one or more items to an alternate form of payment).

At 214, the system determines if any additional non-approved amount is available from the assistance funds. If so, processing continues to 216. If not, processing continues to 218.

At 216, the customer is offered a gift card for the amount of assistance funds determined to be available and that will keep the basket in compliance. In some implementations, the amount charged for a gift card can include a fee (e.g., a percentage of the card value or a flat fee) paid to the system (e.g., SNAPit-UP basket system) owner or operator. The additional financial instrument provided with an assistance program basket can include a custom assistance program basket card (e.g., a SNAPit-UP card that can be used anywhere), a credit line with one or more stores, a gift card or other form of financial instrument.

Also, the system can generate audit reports for various purposes such as documenting compliance with assistance program rules, documenting amounts of gift cards purchase and fees paid to the system owner or operator to ensure fee compliance, etc.

At 218, the sale is completed.

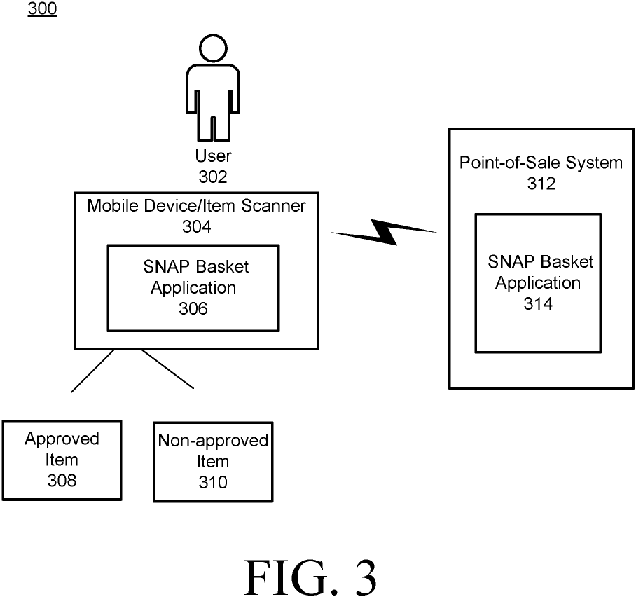

FIG. 3 is a diagram showing an example environment 300 including an example handheld electronic automated assistance program basket (e.g., SNAP basket) product generator and associated point of sale system in accordance with some implementations. In the environment 300, a user (or customer) 302 uses a mobile device or dedicated scanner 304 that includes an assistance basket application 306 to scan items 308/310 for an assistance basket purchase. The mobile device/scanner 304 can communicate with a point-of-sale system 312 that can also include an assistance basket application 314.

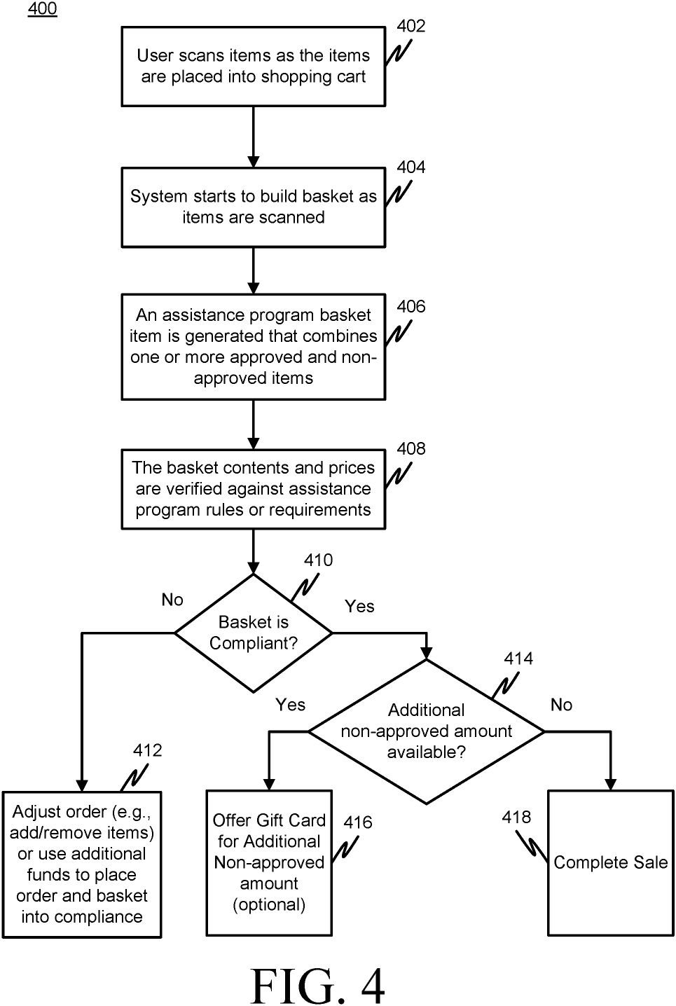

FIG. 4 is a flowchart showing an example method 400 for automated assistance program basket (e.g., SNAP basket) product generation and user checkout via a combination of a handheld scanner and an associated point-of-sale system in accordance with some implementations. Processing beings at 402, where a user or customer uses a mobile device (e.g., a smartphone) or a scanning device to scan items for an assistance basket as the items are placed into a shopping cart. Processing continues to 404.

At 404, the system automatically builds an assistance basket item as the individual items (approved or non-approved) are scanned. The items can include one or more approved items and, optionally, one or more non-approved items. Processing continues to 406.

At 406, an assistance program basket item (e.g., a SNAP basket) is generated by a basket application that is part of or coupled to the POS, where the basket combines one or more approved items and, optionally, one or more non-approved items. Processing continues to 408.

At 408, the basket contents and prices are used to verify compliance with assistance program rules, requirements or guidelines. For example, in some assistance programs such as SNAP, the non-approved item total must be less (even if by only $0.01) than the approved item total. Processing continues to 410.

At 410, the system determines if the basket is compliant. If so, processing continues to 414. If not, processing continues to 412.

At 412, the customer’s order can be adjusted (e.g., one or more approved or non-approved items removed or added) or the customer can provide additional non-assistance program funds to place the basket order into compliance (e.g., by moving one or more items to an alternate form of payment).

At 414, the system determines if any additional non-approved amount is available from the assistance funds. If so, processing continues to 416. If not, processing continues to 418.

At 416, the customer is offered a gift card for the amount of assistance funds determined to be available and that will keep the basket in compliance.

At 418, the sale is completed. In some implementations, a user or customer can save a favorite or recently purchased basket for later use such a stored basket can be retrieved later by a user or customer to speed the checkout process and also to ensure that the favorite or stored basket still meets programs requirements at a later date (when prices or program rules may have changed) to help reduce or eliminate issues at checkout.

Steps 402-410 or similar steps can be performed by retailer or manufacturer to pre-make a physical basket that includes specific items meeting the assistance program rules, and which has been assigned a barcode or SKU number. The POS system, when that physical basket is scanned, can identify the individual products and list those separately and ensure that the assistance program rules for the premade physical basket are met at time of checkout and payment.

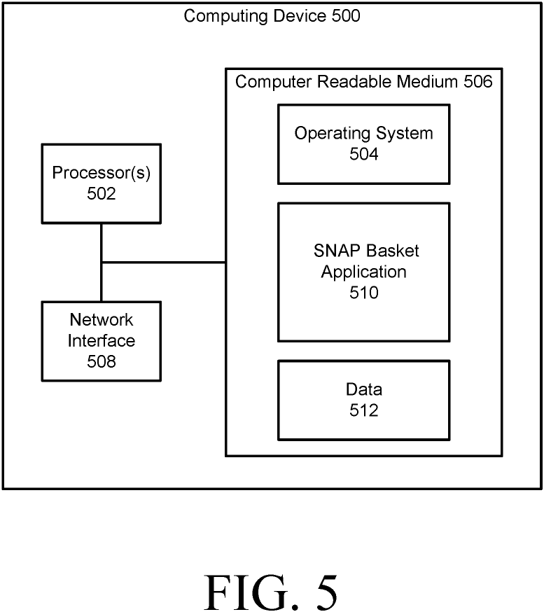

FIG. 5 is a diagram of an example computing device 500 in accordance with at least one implementation. The computing device 500 includes one or more processors 502, nontransitory computer readable medium 506 and network interface 508. The computer readable medium 506 can have stored thereon one or more of an operating system 504, an application 510 for automated assistance program basket (e.g., SNAP basket) product generator and point of sale system in accordance with some implementations, and a data section 512 (e.g., for storing generated SNAP baskets, customer orders, sales records, assistance program requirements, etc.).

In operation, the processor 502 may execute the application 510 stored in the computer readable medium 506. The application 510 can include software instructions that, when executed by the processor, cause the processor to perform operations to provide automated assistance program basket (e.g., SNAP basket) product generation and electronic point of sale services in accordance with the present disclosure (e.g., performing associated functions described above and in FIGS. 2 and 3).

The application program 510 can operate in conjunction with the data section 512 and the operating system 504.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multicore, or cloud computing system). Also, the processes, system components, modules, and submodules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media to provide automated assistance program basket (e.g., SNAP basket) product generation and associated electronic point of sale services.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A computer implemented method comprising:
receiving an indication that a customer desires to use an assistance program form of payment;
scanning items for an order;
generating an assistance program basket item including one or more approved items and one or more non-approved items;
verifying compliance of the assistance program basket with assistance program rules;
when the assistance program basket is not compliant with the assistance program rules,
permitting a customer to adjust the assistance program basket or provide funds from a non-assistance program source to bring the assistance program basket into compliance;
when additional funds are available from the assistance program while still keeping in compliance with the assistance program rules, providing the customer with an option to receive the additional funds as a gift card; and
completing the sale of the assistance program basket.
